(19) United States
(12) Patent Application Publication
(10) Pub. No.: US 2020/0294087 A1
(43) Pub. Date: Sep. 17, 2020

(54) HYPER-LOCAL TEMPORALLY RELEVANT WEATHER TRIGGERED DYNAMIC MESSAGING

(71) Applicant: DTN, LLC, Omaha, NE (US)

(72) Inventors: Sara Livingston, Woodmere, NY (US); Amanda Swistock, New York, NY (US); Steve Kelley, Riverdale, NY (US); Ajit Srivastava, North Brunswick, NJ (US); Vikram Somaya, New York, NY (US)

(21) Appl. No.: 16/888,514

(22) Filed: May 29, 2020

Related U.S. Application Data
(62) Division of application No. 14/217,582, filed on Mar. 18, 2014, now abandoned.

(51) Int. Cl. G06Q 30/02

(52) U.S. Cl. CPC G06Q 30/0252

(57) ABSTRACT

Methods and systems for substantially real-time modeling based on geographical and temporarily-modified weather data, client goals and historical business data to present localized advertising to influence consumer behavior. By overlaying sales information with weather data and predictive analytical models, dynamic messaging (e.g., advertising) may be delivered on a hyper-local basis across the web, television broadcast and cable, mobile devices and tablets automated in real-time. Further, the dynamic messaging may be tailored to specific marketers and their business. The messages may be created for each of the marketer's locations in a way that can be scaled.

### BACKGROUND OF THE DISCLOSURE

Economic data has shown that weather conditions have an impact on sales of products and services. Simply stated, bad weather keeps people at home. In particular, rain, snow and extreme temperatures have been indentified as factors that make shopping less desirable. Weather also influences sales volume and store traffic in particular product categories. For example, when temperatures fall, ice cream sales decrease, while sales of oatmeal increase. Similarly, people tend to purchase more clothing and footwear in the winter and more food and drinks in the summer.

Retailers are aware of such effects and use weather as a cue to begin and end merchandising seasons. For example, gardening supplies begin to appear on store shelves with the arrival of spring weather, while the sale of snow shovels coincides with the onset of winter. In general, some products are better suited to, or even designed for, particular types of weather. However, while there is a general understanding that weather affects sales, there have not been attempts to apply this understanding to current and forecast weather conditions in attempt to drive future sales of products and services.

### SUMMARY OF THE DISCLOSURE

The present disclosure is directed to media content creation and dynamic message targeting technology/system that targets such messages based on geographically relevant weather events. In accordance with an aspect of the disclosure, there is provided a method of providing geographically-targeted dynamic messages in accordance with weather conditions. The method includes storing weather triggers that contain rules to initiate communication of dynamic messages in accordance with predetermined weather conditions; obtaining current weather conditions for a geographical location; applying the rules in the weather triggers to the current weather conditions; and communicating a dynamic message to the geographic location if the rules in a weather trigger associated with the geographic location are satisfied.

In accordance with another aspect of the disclosure, there is provided a method of triggering a geographically-targeted dynamic message. The method includes obtaining first data associated with a first event type; obtaining second data associated with a second event type; correlating the second data to the first data to determine statistically significant first events that affect the second events; defining triggers that contain rules, the rules for each trigger being at least one combination of statistically significant first events for a geographic area; applying the rules in the triggers to monitored first event types; and initiating the geographically-targeted dynamic message in response to the rules of a trigger being satisfied.

In accordance with yet another aspect of the disclosure, there is provided a method of targeting a geographically and temporally relevant weather-driven marketing messages. The method includes retrieving current and forecast weather conditions for a geographic location; comparing the current and forecast weather condition to predetermined weather conditions defined in a trigger associated with the geographic location; and initiating a communication of the geographically and temporally relevant weather-driven marketing messages when the predetermined weather conditions defined in the trigger are satisfied by the current and forecast weather conditions.

This summary serves as an introduction to the subject matter of the disclosure. These and other features will be described in more detail below.

### BRIEF DESCRIPTION OF THE DRAWINGS

The present disclosure is described with reference to the accompanying drawings. In the drawings, identical reference numbers indicate identical or functionally similar elements.

FIG. 1 illustrates an example system that implements the methods of the present disclosure;

FIG. 2 illustrates an example high-level operational flow performed by the system of FIG. 1;

FIG. 3 illustrates an example operational flow to create a trigger in accordance with the present disclosure;

FIG. 4 illustrates an example operational flow executed by a trigger engine in the system of FIG. 1;

FIG. 5 illustrates an example operational flow by which an advertising campaign is initiated for “on-property” media channels or platforms;

FIG. 6 illustrates an example operational flow for serving dynamic messages to an end user device viewing an on-property media channel or platform;

FIG. 7 illustrates an example operational flow by which an advertising campaign is initiated for “off-property” media channels or platforms;

FIG. 8 illustrates an example operational flow for serving dynamic messages to an end user device viewing an off-property media channel or platform; and

FIG. 9 shows an exemplary computing environment in which example embodiments and aspects may be implemented.

### DETAILED DESCRIPTION OF THE DISCLOSURE

Overview

The present disclosure describes methods and systems that implement substantially real-time modeling based on geographical and temporarily-modified weather data and historical business and weather data to present localized dynamic messages, such as advertising, informational messages, and emergency notifications. With respect to historical sales, marketing and/or business data, by overlaying this information with weather data and predictive analytical models, marketing messages may be delivered on a hyper-local basis across the web, television broadcast and cable, mobile devices and tablets in real-time or dynamically to influence consumer behavior. Further, the advertising may be tailored to specific marketers and their business. The advertising may be created for each of the marketer's locations in a way that can be scaled.

System Architecture Diagram

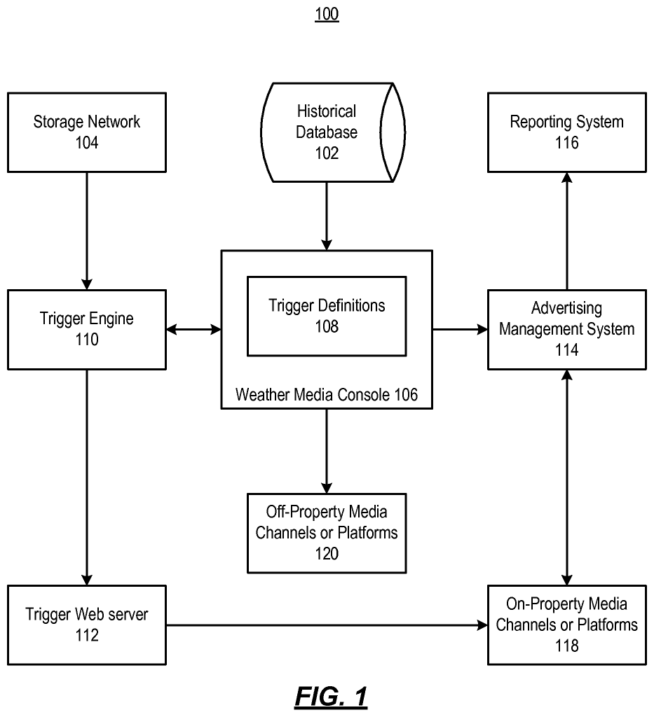

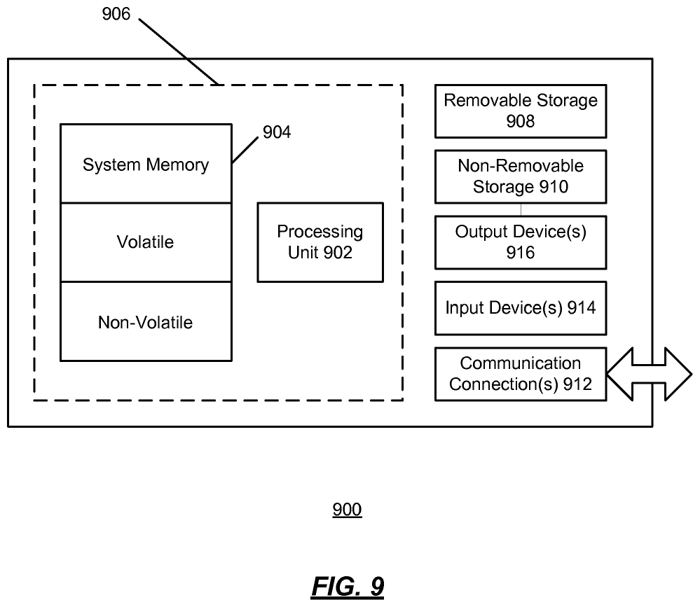

FIG. 1 illustrates an example system 100 that implements the methods of the present disclosure. The architecture includes a historical database 102 of sales and weather data, a storage network 104 that serves as a data distribution system, and a weather media console 106 that provides a user interface and maintains weather trigger definitions 108. A trigger engine 110 applies the weather trigger definitions 108 to determine what dynamic messages should be displayed in view of, e.g., historical sales, marketing and/or business data and weather data contained in the historical database 102 and the current and forecast weather in the storage network 104, and communicates information about the dynamic messages to a web server 112. The system 100 further includes an advertising management system 114, a reporting system 116, “on-property” media channels or platforms 118 and “off-property” media channels or platforms 120, as described below. It is noted that each of the components of the system 100, may be executed on a computing device, such as that shown in FIG. 9.

The historical database 102 maintains historical weather data may be provided by observational weather stations, the National Weather Service, and other providers (e.g., Weather Underground). The data may extend back, e.g., 10 years or more. The historical weather data is used in the creation of triggers, as described below. In accordance with some implementations, the weather data in the historical database 102 is compiled and refined to enhance its usability. For example, the weather data may be segmented based on season ranges to cover core seasons and seasonal transition periods (e.g., six segments). The ranges may be expressed as date ranges unique to a geographic location. Weather data within each season is then analyzed to determine an average and Standard Deviation (SD). Standard deviations may be relative and express that, e.g., a weather condition is 80% likely to occur, or that a weather combination is likely to occur in a particular ZIP Code. From that, a normal distribution curve is established and weather data is broken out into ranges based on SD increments (“buckets”). Optionally or additionally, an outlier treatment may be applied to remove extreme conditions. Such conditions may be placed into a separate bucket. From the above, relative condition ranges may be defined, such as, but not limited to, “above average X,” and “below average X.”

The historical database 102 also maintains sales, marketing and/or business data that is directly uploaded by first parties (e.g., clients of the system 100) to provide detailed product/product groups transactional information; or sales, marketing and/or business data provided by third party companies that provide aggregation-based data and/or cookie-based data(e.g., RevSci, BlueKai, Lotame, Nielsen, Datalogix, etc.). For example, the first party data may be store-level transaction data. The sales, marketing and/or business data is used in the creation of the weather trigger definitions 108 for general categories of products (from third party data) or a client's specific products (from first party data).

The historical database 102 may be provided as a cloud-based storage facility and data warehouse service, such as Amazon S3 and Redshift, however, other alternatives may be used in combination with, e.g., a cloud management platform. The historical weather and sales, marketing and/or business data may be initially uploaded as data sets to the cloud-based storage facility where it is staged. The data may be moved into the data warehouse service to make it accessible to the system 100. For example, the data may be mapped and stored in relational format. From that, the data may be manipulated into data sets.

The storage network 104 provides a common repository for storing weather data, content, images and videos from multiple sources and also serves as a centralized data distribution system. The storage network 104 may be geographically dispersed in order to efficiently distribute data throughout large geographics areas, such as a continent. Access to the storage network 104 may be monitored, metered and throttled through an API management system. Data may be ingested by the storage network 104 using, e.g., ingestion APIs which provide the data to message queues, data processing engine (DPE) instances, and various data cartridges. A DPE is an application that reads the daily forecast from the message queue and incorporates business logic from the data cartridges. For example, a task of the DPE may be to read forecast data from the queue, format it in a specific way, and provided to a database within the storage network 104.

The weather media console 106 and the weather trigger definitions 108 utilize historical weather and sales, marketing and/or business data to dictate/prompt/decision weather triggered dynamic messages (e.g. advertising or other messages) on both on-property media channels or platforms 118 and off-property marketing channels or platforms 120. The media channels or platforms may be any medium by which the dynamic messages are delivered, e.g., mobile, web, broadcast, cable, social (Twitter, Facebook, etc.), radio, satellite, e-mail, SMS, desktop applications, in-store digital displays, digital out-of-home (OOH) advertising, etc. Further, the weather trigger definitions 108 may provide business insight that may be used for marketing and other purposes. “On-property” media channels or platforms are those media channels or platforms provided by an operator of the system 100. “Off-property” media channels or platforms are those media channels or platforms not provided by an operator of the system 100, but that utilize the services of the system 100. Different levels of information may be able to be derived about visitors to on-property media channels or platforms 118 and off-property media channels or platforms 120.

The weather media console 106 is the main User Interface (UI) to components in the system 100 and the primary housing mechanism for the weather trigger definitions 108. The weather media console 106 may be used to manage features such as bidding and campaign management. For example, a list of the applicable weather trigger definitions 108 (e.g., current and 1- and 2-day forecast) is sent from trigger engine 110 to a data bidder component. The data bidder then uses the trigger definitions 108 to generate segments. These segments are then associated with campaigns. Creatives are uploaded and assigned to the campaigns. Reporting on these campaigns can then be tracked via the reporting system 116. In addition, bid requests (e.g., ad calls) that are received by the weather media console 106 may be enhanced with relevant segments that add weather trigger definitions 108 as additional targeting parameters to the request.

The weather trigger definitions 108 may be initially created or updated in a spreadsheet file (e.g., EXCEL), XML document, flat file, comma separated value file, or any other suitable format, and are uploaded to the weather media console 106. For example, each row in the spread sheet may identify a trigger, and each column may specify criteria associated with the trigger. For example the columns may specify: a bucket name, a bucket ID, a geographic identifier, a start date, an end date, one or more weather conditions (as relative or raw values), and rules to specify relationships between specified ones of the weather conditions (e.g., complex Boolean operators). In some implementations, each weather trigger in the spreadsheet file may be assigned a unique name to maintain a one-to-one relationship of names to weather triggers. In other implementations, the name may be applied to more than one weather trigger, in order for the weather trigger to be applied as to a group of more than one product having similar sales, marketing and/or business data associated therewith. Once uploaded to the weather media console 106, each trigger name is assigned a unique numeric ID. If the uploaded trigger name already exists in weather media console 106, the trigger's buckets are updated with the latest definition from the spreadsheet. For consistency, weather trigger names and IDs are not deleted although their underlying buckets and conditions may be updated, deleted and changed. Once the line items are configured and associated with weather triggers, they are provided to the advertising management system 114.

The individual weather trigger definitions 108 may be one of several types. A non-limiting example includes relative condition triggers, which contain historical weather data. These may be used to define concepts such as very hot, very cold by combining one or more weather conditions (e.g., each with average and standard deviation ranges). Another non-limiting example is Product Triggers or Activity Triggers (“Standard Triggers”),which contain third party sales, marketing and/or business data (i.e., category generic) plus historical weather data. Enterprise triggers contain first party sales, marketing and/or business data (i.e., product or location specific) plus historical weather. The Enterprise trigger is similar to the standard trigger, except that it uses specific client sales, marketing and/or business data, rather than third party category data. As such, the Enterprise trigger may be used to trigger dynamic messages for specific products, rather than a category of products based on geographically-relevant weather conditions. Additional trigger types may be defined and the details regarding the creation of triggers is provided with reference to FIG. 3.

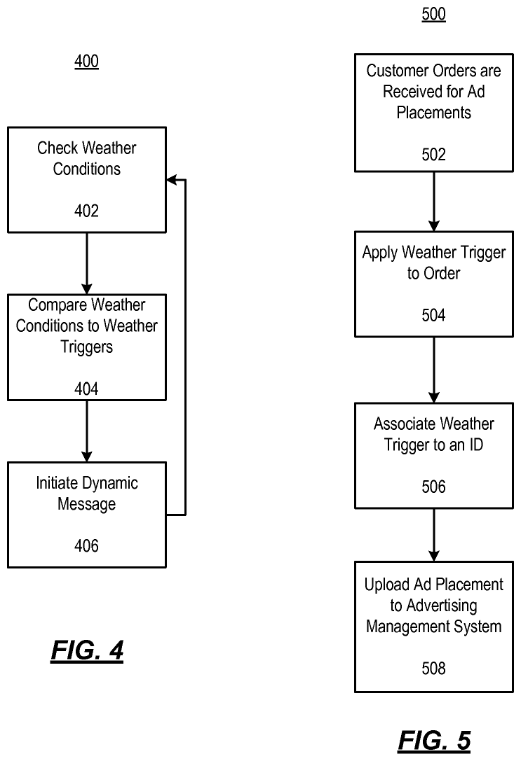

The trigger engine 110 applies the trigger definitions 108 created at the weather media console 106 across specified media channels or platforms. The trigger engine 110 may be a cloud-based decisioning engine containing all of the weather trigger definitions 108 maintained by the system 100. Current and forecast weather data provided by the storage network 104 to the trigger engine 110 to provide the trigger web server 112 (ad/media serving element) with information to properly target dynamic messages as part of, e.g., advertising campaigns. Details of the processes performed by the trigger engine 110 are provided with reference to FIG. 4.

With regard to the media channels or platforms, for online display, dynamic message creation based on the trigger definitions 108 may be performed substantially in real time. For social media, the dynamic message creation may take longer, as such messaging is pushed out into a social media feed (e.g., Twitter using the Twitter API or Facebook by insertion into the newsfeed). For television and cable, dynamic messages may be provided to a broadcaster or Multiple Service Operator (MSO) for insertion into advertising slots.

The advertising management system 114 may finalize the setup of orders, activate specific marketing messages, insure actual delivery of the dynamic messages, test the activation of dynamic messages (e.g., test an advertising campaign using test keywords), troubleshoot problems, and report delivery information for the associated line items. When content associated with on-property media channel or platform 118 is loaded, the advertising management system 114 receives the call from a tag on the page. The tag contains dimensions, location/position and the ID of the weather FX trigger being targeted. The advertising management system 114 then evaluates active campaigns to see if any of the pages, locations and targeting parameters match the tag from which it received the call. Priority and front loading settings may be taken into consideration as well. If a campaign is eligible, the advertising management system 114 will log an impression and serve the dynamic message as a marketing message, such as an advertisement.

The reporting system 116 may generate invoices, associate them with customer accounts, email the customer the invoice and create applicable journal entries for the recording of revenue. The reporting system 116 may also aggregate metrics on campaign delivery, such as third party accounting data about ad serving/tracking (impression/click metrics). The reporting system 116 provides a view of all tracking data being gathered by third party vendors.

Thus, the system 100 is configured to display dynamic hyper local messages. The messages, such as advertising, are based on how weather conditions affect sales of products and/or services. Further, the dynamic messages may be derived from sentiment data. For example, sentiment may be derived by analyzing geo-located tweets or from questionnaires. Corroboration of a set of weather conditions to a location using sentiment data may further refine the dynamic messages.

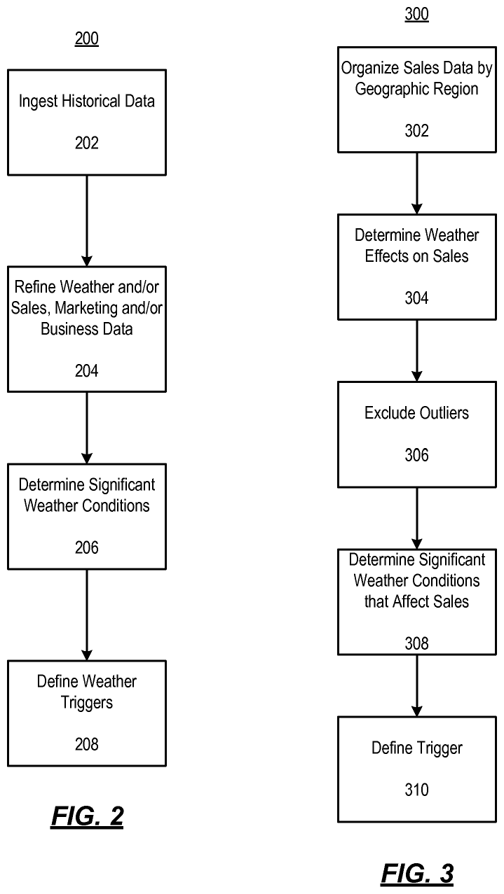

FIG. 2 illustrates an example high-level operational flow 200 performed by the system 100. At 202, historical data is ingested by the system 100. This information may include historical weather information and/or sales, marketing and/or business data that is ingested into the historical database 102. At 204, the weather and/or sales, marketing and/or business information may be refined. As noted above, the weather information may be segmented based on season ranges and analyzed to determine an average and Standard Deviation (SD). The sales, marketing and/or business data may be refined to exclude discounting, major sales, etc. At 206, significant weather conditions are determined. The data may be further analyzed to determine most significant weather conditions for a geographic location and season that caused a significant impact on sales of a product. At 208, weather triggers are defined. The weather triggers are defined to generate a dynamic message for a geographic location based on an occurrence of the weather condition in the geographic location in the particular season of interest. Steps 202-208 may be executed and/or repeated during the operation of the system 100.

FIG. 3 illustrates an example operational flow 300 to create a trigger in accordance with the present disclosure. At 302, sales, marketing and/or business data is organized. To create a standard trigger, sales, marketing and/or business data may be organized by a geographic location (e.g., ZIP code or Designated Market Area (DMA), or other identifier as understood by one of ordinary skill in the art). At 304, the sales, marketing and/or business data is organized to determine weather effects. A regression analysis may be performed to determine which weather conditions create, e.g., a significant sales increase for that geographic area. For example, there may be tens of weather conditions analyzed. A non-limiting sample list of weather conditions includes: High Temp (F), Low Temp (F), Temperature, Wind Speed, Wind Direction, Relative Humidity, Cloud Cover, and Precipitation amount for a previous 24 hours. At 306, the sales, marketing and/or business data may be analyzed to determine outliers. The data may be further normalized to exclude big discounting, major sales, etc., that may skew the data and to analyze other outliers. Next, at 308, the most significant weather conditions (e.g., the top two) are determined for the geographic location and season that caused a significant impact on sales of a product. At 310, the trigger is defined. For example, a standard trigger may be defined from this information to trigger dynamic messages (e.g., advertising) based on occurrence of the weather condition in the geographic location in the particular season of interest. Each standard trigger may be assigned a priority depending on the probability of occurring. Each trigger may have up to six buckets of probability (i.e., standard deviations), in each of which there may be individual conditions with ranges. Thus, the trigger correlates weather conditions with significant sales lifts.

FIG. 4 illustrates an example operational flow 400 executed by the trigger engine 110. The operational flow 400 may be executed concurrently by the system 100 with the operational flow 200. At 402, the trigger engine checks weather conditions. In some implementations, the trigger engine may call an Application Programming Interface (API) to check and capture the current/real-time weather conditions. The API call may be made by the trigger engine 110 every 10 minutes (or other configurable period, or real-time) to retrieve the current weather data from the storage network 104. The weather conditions may be geographically indexed. At 404, the trigger engine compares the weather conditions to active triggers. The trigger engine 110 may compare the retrieved current weather against all active weather triggers to determine which triggers are applicable for the next 10 minutes (i.e., the configured period). The weather triggers may be cached at the trigger engine 110. At 406, matching trigger(s) are fired to initiate communication of dynamic messages. The applicable triggers may be cached, so that when the trigger engine 110 is called from the web server 112, the applicable trigger and dynamic messaged will fire and be served. For example, audio, video, images, etc. may be retrieved from the storage network 104 and presented to an end user in a format appropriate for a distribution channel (e.g., mobile, web, television, SMS, e-mail, etc.). Thus, the trigger engine 110 determines which dynamic messages should be served to a particular location by applying the trigger definitions 108 to the weather conditions.

In some implementations, the dynamic message may be “hyper-local advertising” that is provided in response to a forecast on-demand. For example, a user may request a forecast for a location X. The system 100 may geo-fence every Company A store, and push a focused message for the stores within a geo-fenced area in location X. Such an implementation advertises a product that is within a close range of the user, e.g., within 5 miles of location X.

FIG. 5 illustrates an example operational flow 500 by which an advertising campaign is initiated for “on-property” media channels or platforms. At 502, customer orders may be received for advertising placement. The placement may be within a line item. At 504, a Weather Trigger (WT) is applied to an order. The Weather Trigger (WT) may be applied to an order by selecting the Ad Product (e.g., dynamic message) that has been created to represent the trigger. At 506, the Weather Trigger is associated with an ID. At 508, the placement is uploaded. The placement may be uploaded to the advertising management system 114 and the weather media console 106 in order for the campaign to go live.

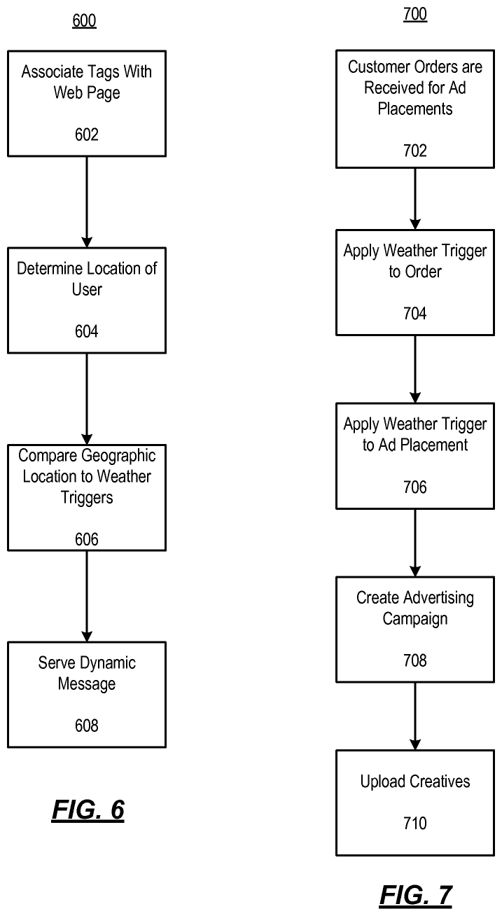

FIG. 6 illustrates an example operational flow 600 for serving dynamic messages to an end user device viewing an on-property media channel or platform. At 602, tags are associated with web pages. For example, web pages associated with on-property media channels or platforms may include two tags. One is a trigger engine tag (TE tag) and the other is a campaign management system tag. At 604, a location of a user viewing the web page is determined. When a user visits an on-property page, the TE tag captures the user's IP address and derives the ZIP code or other geographic identifier. This derivation may be performed using e.g., Neustar for on-line and tablet, and latitude/longitude for mobile users if the user has opted in. At 606, the geographic identifier is compared to relevant triggers. For example, the ZIP code may be compared the cached list of relevant triggers stored by the trigger engine 110 based on current weather conditions. At 608, a dynamic message is determined and served. The trigger engine 110 then provides the tag with a list of triggers currently applicable for the geographic identifier and sends it to the advertising management system 114. The advertising management system 114 then analyzes the list sent from the TE tag, and evaluates it against campaigns other settings (e.g., priority, pacing, CPM, frequency capping, exclusions) to determine which marketing message to serve. The advertising management system 114 then selects a marketing message and serves its creative. In some implementations, geographic targeting options may be applied such that the advertising management system 114 serves a marketing message for a location that the user is looking at (“contextual geotargeting”).

FIG. 7 illustrates an example operational flow 700 by which an advertising campaign is initiated for “off-property” media channels or platforms. The process at steps 702-704 for off-property media channels or platforms is the same as steps 502-504 for on-property media channels or platforms. Next, at 706, a placement is selected within a line item and a Weather Trigger (WT) is applied to it by selecting the Ad Product that has been created to represent the trigger. The line item is then pushed to the weather media console 106. At 708, the advertising campaign is created. Here, the advertising campaigns, including all parameters, are created and segments are then applied to them. At 710, creatives for the campaigns are uploaded and assigned to campaign. This assignment may be performed in the weather media console 106.

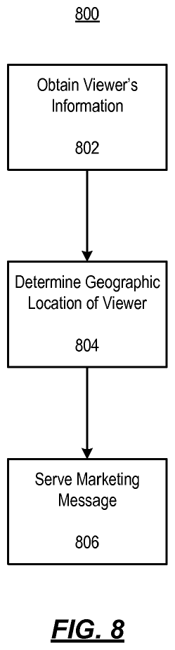

FIG. 8 illustrates an example operational flow 800 for serving dynamic messages to an end user device viewing an off-property media channel or platform. At 802, information regarding a viewer of the off-property media channel or platform is obtained. For example, web pages associated with off-property media channels or platforms may include the trigger engine tag (TE tag) to captures the user's IP address and to derive the ZIP code or other geographic identifier. At 804, the geographic location of a view of the off-property media channel or platform is determined. The ZIP code may be compared the cached list of relevant triggers stored by the trigger engine 110 based on current weather conditions. At 806, the marketing message to be served is determined. For example, the trigger engine 110 then provides the tag with a list of triggers currently applicable for the geographic identifier and the weather media console 106 determines which marketing message to serve. The marketing message is then served to the off-property media channel or platform using the web server 112.

FIG. 9 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 9, an exemplary system for implementing aspects described herein includes a computing device, such as computing device 900. In its most basic configuration, computing device 900 typically includes at least one processing unit 902 and memory 904. Depending on the exact configuration and type of computing device, memory 904 may be volatile (such as random access memory (RAM)), non-volatile (such as read-only memory (ROM), flash memory, etc.), or some combination of the two. This most basic configuration is illustrated in FIG. 9 by dashed line 906.

Computing device 900 may have additional features/functionality. For example, computing device 900 may include additional storage (removable and/or non-removable) including, but not limited to, magnetic or optical disks or tape. Such additional storage is illustrated in FIG. 9 by removable storage 908 and non-removable storage 910.

Computing device 900 typically includes a variety of tangible computer readable media. Computer readable media can be any available tangible media that can be accessed by device 900 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 904, removable storage 908, and non-removable storage 910 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of computing device 900.

Computing device 900 may contain communications connection(s) 912 that allow the device to communicate with other devices. Computing device 900 may also have input device(s) 914 such as a keyboard, mouse, pen, voice input device, touch input device, etc. Output device(s) 916 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

While the present disclosure has been described in connection with various implementations shown in the figures, it is to be understood that other similar implementations may be used or modifications and additions may be made to the described implementations for performing the same function of the present disclosure without deviating therefrom. For example, one skilled in the art will recognize that the implementations as described in the present disclosure may apply to any computing device or environment, and may be applied to any number of such computing devices connected via a communications network, and interacting across the network. Furthermore, the present disclosure may be implemented in or across a plurality of processing chips or devices, and storage may similarly be affected across a plurality of devices. Therefore, the present disclosure should not be limited to any single embodiment, but rather should be construed in breadth and scope in accordance with the appended claims.

What is claimed:

1. A method of providing geographically-targeted dynamic messages in accordance with weather conditions, comprising:
storing weather triggers that contain rules to initiate communication of dynamic messages in accordance with predetermined weather conditions;
obtaining current weather conditions for a geographical location;
applying the rules in the weather triggers to the current weather conditions; and
communicating a dynamic message to the geographic location if the rules in a weather trigger associated with the geographic location are satisfied.

2. The method of claim 1, further comprising:
storing a plurality of creatives associated with the dynamic message for the geographical location; and
selecting one of the plurality of creatives in accordance with the rules in the weather trigger associated with the geographic location being satisfied.

3. The method of claim 2, further comprising communicating the one of the plurality of creatives to a server for distribution to end users.

4. The method of claim 1, wherein the dynamic message is a marketing message.

5. The method of claim 1, further comprising defining the rules as statistically significant combinations of weather conditions associated with a subject of the dynamic message.

6. The method of claim 5, further comprising:
obtaining historical weather data for a geographical location;
obtaining historical sales, marketing and/or business data for the geographical location; and
determining the statistical significance as an increase of product sales based on weather conditions in the historical weather data.

7. The method of claim 6, wherein the historical weather data and the sales, marketing and/or business data are geographically indexed.

8. The method of claim 1, further comprising:
obtaining forecast weather conditions;
applying the rules in the weather triggers to the forecast weather conditions; and
communicating a dynamic message to the geographic location if rules in a weather trigger associated with the geographic location are satisfied by the forecast weather conditions.

9. The method of claim 8, further comprising communicating the dynamic message over a period associated with the forecast weather conditions.

10. The method of claim 1, further comprising periodically performing the method to refresh the dynamic message for the geographic location.

11. A method of triggering a geographically-targeted dynamic message, comprising:
obtaining first data associated with a first event type;
obtaining second data associated with a second event type;
correlating the second data to the first data to determine statistically significant first events that affect the second events;
defining triggers that contain rules, the rules for each trigger being at least one combination of statistically significant first events for a geographic area;
applying the rules in the triggers to monitored first event types; and
initiating the geographically-targeted dynamic message in response to the rules of a trigger being satisfied.

12. The method of claim 11, further comprising organizing the first data and the second data in accordance with predetermined geographical areas.

13. The method of claim 11, further comprising assigning a priority to the triggers.

14. The method of claim 11, further comprising:
monitoring current first event types and forecast first event types; and
initiating the geographically-targeted dynamic message in response to the rules of a trigger being satisfied by either of the current first event types and forecast first event types.

15. The method of claim 11, wherein the first event type is weather events and wherein the second event type are sales of products and/or services.

16. The method of claim 15, wherein the geographically-targeted dynamic message is a marketing message for a product or service that is initiated in response to a weather event.

17. A method of targeting a geographically and temporally relevant weather-driven marketing message, comprising:
retrieving current and forecast weather conditions for a geographic location;
comparing the current and forecast weather condition to predetermined weather conditions defined in a trigger associated with the geographic location; and
initiating a communication of the geographically and temporally relevant weather-driven marketing message when the predetermined weather conditions defined in the trigger are satisfied by the current and forecast weather conditions.

18. The method of claim 17, further comprising defining the predetermined weather conditions as statistically significant combinations of weather conditions associated with sales of a product or service in the geographic location.

19. The method of claim 18, further comprising:
obtaining historical weather data for a geographical location;
obtaining historical sales, marketing and/or business data for the geographical location; and
determining the statistical significance as an increase of product sales based on weather conditions in the historical weather data.

20. The method of claim 17, further comprising:
providing the geographically and temporally relevant weather-driven marketing message for a time period during which the predetermined weather conditions defined in the trigger are satisfied; and
halting the providing once the predetermined weather conditions defined in the trigger are no longer satisfied.
